(19) United States
(12) Patent Application Publication
(10) Pub. No.: US 2014/0298340 A1
(43) Pub. Date: Oct. 2, 2014

(54) VIRTUAL MACHINE SYSTEM, VIRTUALIZATION MECHANISM, AND DATA MANAGEMENT METHOD

(71) Applicant: HITACHI, LTD., Tokyo (JP)

(72) Inventors: Shinya Imaizumi, Tokyo (JP); Takao Totsuka, Tokyo (JP)

(73) Assignee: HITACHI, LTD., Tokyo (JP)

(21) Appl. No.: 14/353,631

(22) PCT Filed: Oct. 3, 2012
(86) PCT No.: PCT/JP2012/075654

§ 371 Date: Apr. 23, 2014

(30) Foreign Application Priority Data
Dec. 13, 2011 (JP) 2011-272629

(51) Int. Cl. G06F 9/455

(52) U.S. Cl. CPC G06F 9/45558; G06F 2009/45583
USPC 718/1

(57) ABSTRACT

Data stored in a memory area of physical memory corresponding to a function read-destination address is accessible in an appropriate manner by a virtual machine. A virtual machine system has a virtual machine management part for managing a virtual machine, and logical processors of virtual machines. The virtual machine management part, on the basis of a physical APCI table, creates a logical APCI table in a logical memory area. A logical processor stores, in an exchange memory area, an address and a size of a memory area in the memory targeted for access by a prescribed function in a control method included in the logical APCI table. The virtual machine management part acquires the address and the size from the exchange memory area, acquires the corresponding memory area data, and stores the acquired data in the logical memory area. The logical processor acquires the data of the logical memory area.

### CROSS REFERENCE TO PRIOR APPLICATION

This application relates to and claims the benefit of priority from Japanese Patent Application No. 2011-272629 filed on Dec. 13, 2011, the entire disclosure of which is incorporated herein by reference.

### TECHNICAL FIELD

The present invention relates to a technique for managing data in an ACPI (Advanced Configuration and Power Interface) table in a virtual machine system that runs a virtual machine.

### BACKGROUND ART

Operation-related complexities have increased in recent years together with increases in the numbers of servers, creating problems in terms of operating costs. The virtual machine system, which brings together a plurality of servers into a single unit, is attracting attention as a technique for lowering operating costs. Logical partition (LPAR)-type virtualization partitions physical computer resources (CPU, main storage, I/O, and so forth), and allocates the partitioned computer resources to a virtual machine. Thus, in an LPAR system, the configuration of the virtual machine will change in accordance with the configuration of the computer resources. Alternatively, a virtual machine (VM) system abstracts the physical computer resources and makes these resources look like a virtual machine. Thus, in a VM system, the configuration of the virtual machine can be freely defined without relying on the configuration of the physical computer.

ACPI is a standard for an OS (Operating System) to obtain information on the configuration of a computer. The ACPI specification is defined in NPL 1. In NPL 1, industry common interfaces for enabling the acquisition of OS-directed motherboard device configuration information and the power management of devices and entire systems are defined.

ACPI functions are provided using two types of ACPI tables: a static table; and a dynamic table capable of being executed by an ACPI interpreter. The ACPI interpreter-executable table is described using the AML (ACPI Machine Language), and a control method is defined internally. The execution of the control method by the ACPI interpreter makes it possible for the OS to use the ACPI functions.

Because the AML is a machine language, readability is low, and it is not possible for a programmer to describe AML directly. Thus, ACPI defines a high-readability source language called the ASL (ACPI Source Language). A programmer can create the AML by compiling source code described using ASL.

### CITATION LIST

### Non Patent Literature

### [NPL 1]

Advanced Configuration and Power Interface Specification Revision 4.0a Apr. 5, 2010, 1 Introduction (P21-32)

### SUMMARY OF INVENTION

### Technical Problem

When an OS on a virtualization machine (hereinafter guest OS) uses ACPI functions, the OS accesses an ACPI table (hereinafter logical ACPI table) defined in the virtual machine. The logical ACPI table depends on the logical hardware recognized by the virtual machine, and the way in which a logical ACPI table is created will differ in accordance with the virtualization method.

In the case of VM-type virtualization, the virtual machine is created by a virtual machine system abstracting the physical computer resources. Thus the structure of the logical hardware recognized by the virtual machine will differ from that of the physical hardware, and a logical ACPI table is uniquely defined for the virtual machine.

Alternatively, in LPAR-type virtualization, the virtual machine is created by partitioning the physical computer resources. Thus, the logical hardware configuration recognized by the virtual machine is similar to that of the physical hardware configuration, and a logical ACPI table is created based on a firmware-defined ACPI table (hereinafter referred to as a physical ACPI table). The logical ACPI table is created by replicating configuration information from the physical ACPI table and the control methods that make use of the ACPI functions. In accordance with this, control methods that make use of the same ACPI functions operate the physical computer and the virtual machine. For example, the bus number of a device is the same for the physical computer and the virtual machine, and as such, it is possible to replicate and use the control method for acquiring the bus number. Next, the portions of the configurations that differ between the virtual machine and the physical computer in the logical ACPI table are edited in accordance with the configuration of the virtual machine. For example, when the number of logical CPUs capable of being defined in the virtual machine differs from the number of physical CPUs mounted in the physical computer (defined in the physical ACPI table), the description of the definition for the number of CPUs in the logical ACPI table is changed.

In the case of a control method for accessing a memory area, simply replicating the control method will not result in normal operation. That is, normal access is not possible when data does not exist in the memory area that the control method accesses.

As a control method for accessing a memory area from the ACPI table, there is a control method that includes a load operator. The load operator is an ASL function used by the control method in the logical ACPI table, and is for loading data from a memory space by specifying an address and a size.

When the guest OS executes a load operator, the address and the size of the data to be read are required as arguments. When the logical ACPI table is created by being replicated from the physical ACPI table, the address read by the load operator is the same address as that of the load operator defined in the physical ACPI table. At this point, different physical memory addresses are accessed even though the same address is accessed when a memory area is accessed from the virtual machine and when a memory area is accessed from the physical computer.

In a virtual machine system, a plurality of virtual machines is running at the same time, and physical memory is partitioned and allocated to each virtual machine. Thus, the physical memory start addresses of the respective virtual machines will vary. In general, the OS is designed on the assumption that a memory area will start from address 0. Thus, the virtual machine system is constructed such that when the virtual machine OS accesses memory, the address to be accessed is translated, and the memory area on the physical memory that has been allocated to the virtual machine (logical memory area) is accessed. For example, when the virtual machine accesses address 0x1000, the virtual machine actually accesses the physical memory at 0x11000 when the start address of the memory area allocated to the virtual machine is 0x10000. Thus, in a case where the load operator of the replicated control method is one that accesses address 0x1000, when the same data as the data at 0x1000 of the physical memory is not at 0x11000 of the physical memory, the load operator cannot be executed normally in the virtual machine. Thus, when executing the load operator, the data to be read by the load operator must be replicated in the memory area of the virtual machine logical memory.

However, when the address and size of the data to be read by the load operator are defined using variables, the address and size of the data to be read by the load operator are not determined until the time point at which the load operator is executed. Thus, the problem is that the data cannot be replicated in a fixed manner in the memory area corresponding to the virtual machine prior to executing the load operator, making it impossible to execute the load operator.

With the foregoing problems in view, an object of the present invention is to provide a technique that enables data stored in a memory area of physical memory corresponding to a read-destination address of a function to be accessed in an appropriate manner by a virtual machine.

### Solution to Problem

A virtual machine system comprises a memory, and a processor that is coupled to the memory, and is capable of running a plurality of virtual machines. The memory stores a physical APCI table. The processor operates as a virtual machine management part (for example, a hypervisor) for managing the virtual machine and logical processors of the virtual machines. The virtual machine management part, on the basis of the physical APCI table, creates logical APCI tables in logical memory areas, which are memory areas in the memory that have been allocated to the virtual machines, a logical processor stores, in a prescribed exchange memory area, an address and a size of the memory area in the memory targeted for access by a prescribed function in a control method included in the logical APCI table, the virtual machine management part acquires the address and the size from the exchange memory area, acquires memory area data corresponding to the address and size from the memory, and stores the acquired data in the logical memory area allocated to the virtual machine, and the logical processor acquires the data of the memory logical memory area.

### Advantageous Effects of Invention

In a virtual machine system that creates a logical ACPI table from a physical ACPI table, data to be read by a prescribed function is replicated from the physical ACPI table into the logical ACPI table, thereby making it possible to read data from the logical ACPI table in an appropriate manner even when the address and size of the data to be read by the function have been defined using variables.

### BRIEF DESCRIPTION OF DRAWINGS

FIG. 1 is a block diagram of a virtual machine system related to the embodiment.

FIG. 2 is a drawing showing an overview of ACPI in the virtual machine system related to the embodiment.

FIG. 3 is a drawing showing an example of a control method including a load operator related to a conventional example.

FIG. 4 is a drawing showing an example of a control method including a load operator related to the embodiment.

FIG. 5 is a drawing showing a summary of processing at load operator execution related to the embodiment.

FIG. 6 is a showing an example of a memory map in a non-virtual machine system.

FIG. 7 is a drawing showing an example of a memory map in a virtual machine system related to the embodiment.

FIG. 8 is a flowchart of a control method execution process related to the embodiment.

FIG. 9 is a flowchart of a control method edit process related to the embodiment.

### DESCRIPTION OF EMBODIMENT

The embodiment of the present invention will be explained by referring to the drawings. The embodiment explained hereinbelow does not limit the invention as in the claims, and not all of the components and combinations thereof described in the embodiment are essential to the solution of the invention.

In the following explanation, there may be cases where the processing is explained having either a program or a program module as the subject of the sentence, but since the stipulated processing is performed in accordance with a program or a program module being executed by a processor (for example, a CPU (Central Processing Unit)) while using a storage resource (for example, a memory) and/or a communication interface device as needed, the processor may be regarded as doer of the processing. A process, which is explained having the program or the program module as the subject, may be regarded as a process that is performed by a processor or an apparatus comprising this processor (for example, a virtual machine system). The program may be installed from a program source. The program source, for example, may be either a program delivery server or a computer readable storage medium.

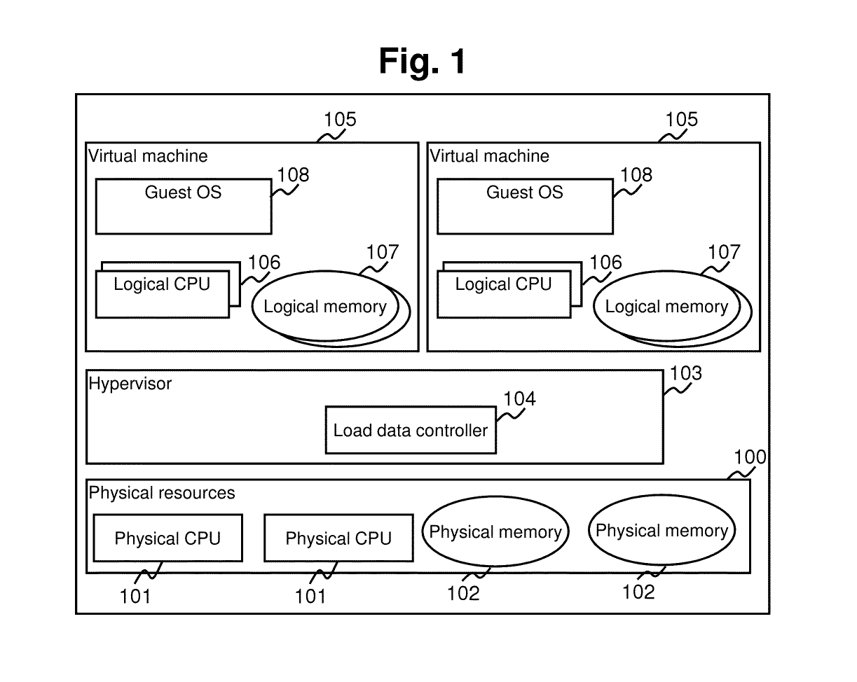

FIG. 1 is a block diagram of a virtual machine system related to the embodiment.

The virtual machine system comprises physical resources 100. The physical resources 100 comprise one or more CPUs 101 and one or more physical memories 102. In the virtual machine system, a plurality of virtual machines 105 can be defined and run using the physical resources 100. The virtual machine 105 comprises a logical CPU 106 and a logical memory 107 as logical resources. The logical CPU 106 is created by logically partitioning the capabilities of one or more physical CPUs 101. The logical memory 107 is a portion of one or more physical memories 102, and is created by logically partitioning one or more physical memories 102. Specifically, the logical memory 107 comprises a storage area (logical memory area) corresponding to an address space of a portion of one or more physical memories 102. In the virtual machine 105, a guest OS 108 operates on the logical resources. That is, the logical CPU 106 executes the guest OS 108.

A hypervisor 103 is booted up on the physical resources 100. The hypervisor 103 is configured in accordance with the physical CPU 101 executing a hypervisor program in the physical memory 102. The hypervisor 103 executes processes for managing the virtual machine 105. In the embodiment, the hypervisor 103 comprises a load data controller 104 for controlling data when a load operator is executed.

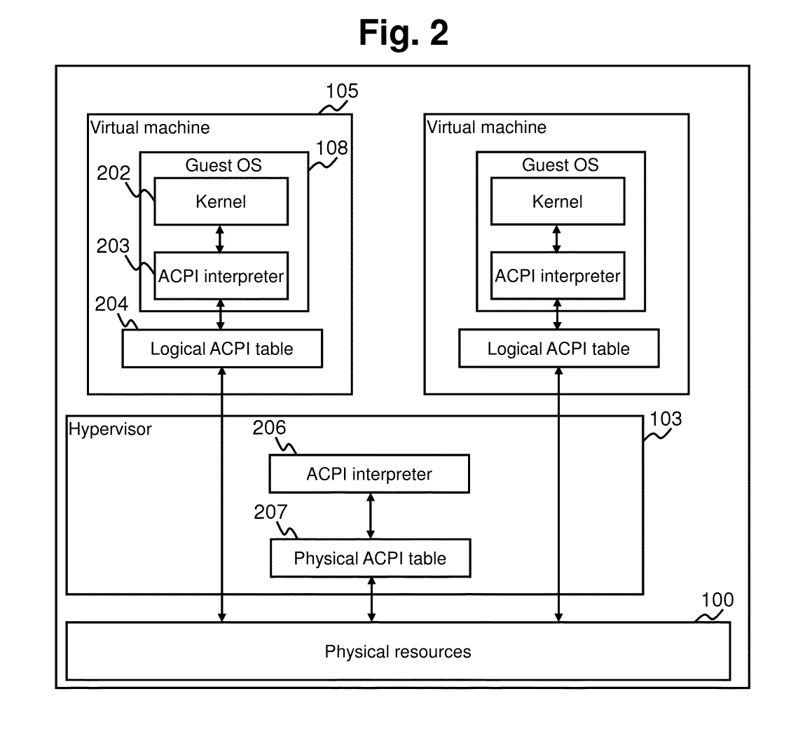

FIG. 2 is a drawing showing an overview of ACPI in the virtual machine system related to the embodiment.

The virtual machine 105 comprises the guest OS 108 and a logical ACPI table 204. The guest OS 108 comprises a kernel 202 and an ACPI interpreter 203. When the guest OS 108 executes a control method, the kernel 202 instructs the ACPI interpreter 203 to execute the control method. The control method is an object for the guest OS 118 to make use of ACPI functions, and is executed by the ACPI interpreter 203. The ACPI interpreter 203 reads a description indicating the processing contents of the corresponding control method from the logical ACPI table 204, and executes the processing.

The hypervisor 103 comprises an ACPI interpreter 206 and a physical ACPI table 207. The physical ACPI table 207 stores the control method. The logical ACPI table 204 of the virtual machine 105 is replicated from the physical ACPI table 207, and is configured by being edited in accordance with the configuration of the virtual machine 105.

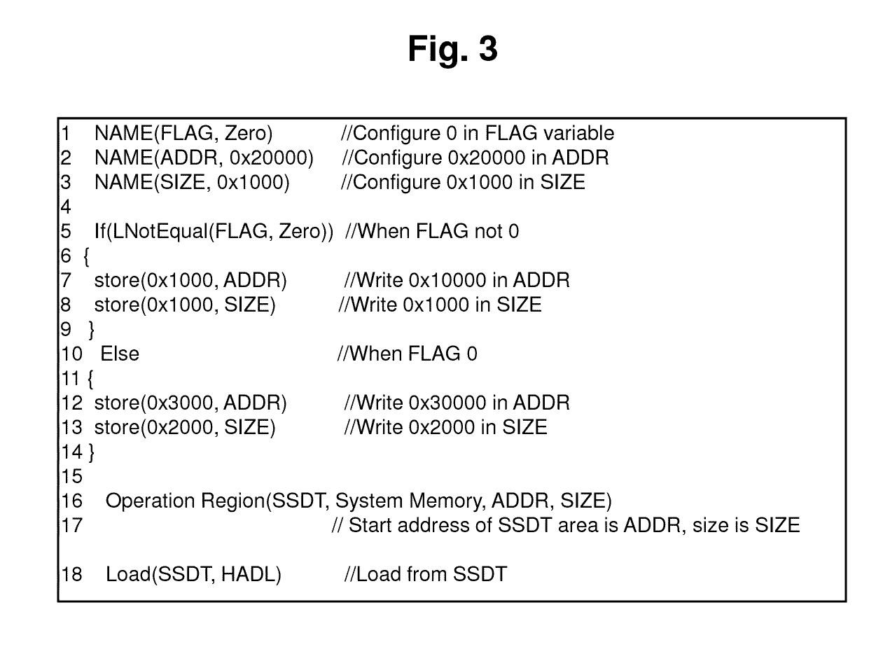

FIG. 3 is a drawing showing an example of a control method including a load operator related to a conventional example. FIG. 3 is an example of a control method that is stored in the physical ACPI table 207.

Lines 1 through 3 of the control method are descriptions for initializing the variables to be used. Lines 5 through 14 of the control method are descriptions for executing the processing of lines 7 and 8 when the value of the FLAG variable in the IF, ELSE statement is not ZERO (the integer 0), and for executing the processing of lines 12 and 13 when the value of the FLAG variable is ZERO. That is, in the processing corresponding to the descriptions therebetween, the values of an ADDR variable and a SIZE variable change in accordance with the value of the FLAG variable.

Line 16 of the control method is a description for declaring an area of memory to be read by the load operator. Line 18 of the control method is a description for executing the load operator and reading from a memory area a SIZE bytes' worth of data from a start address ADDR. In this control method, the address (value of ADDR variable) and the size (value of SIZE variable) of data to be read by the load operator is not determined until execution has proceeded to the processing of line 15 and beyond.

At this point, the logical ACPI table 204 is created based on the physical ACPI table 207. Thus, when the control method has simply been replicated, the address and size of the data to be read by the load operator included in the control method of the physical ACPI table 207 remain as described in the physical ACPI table 207.

When this control method is executed in the virtual machine 105, the load operator reads data from the logical ACPI table 204 in the logical memory 107, but when the data to be read has not been replicated from the physical ACPI table 207 in the corresponding area of the logical memory 107, the data is not read normally.

Accordingly, in the embodiment, the hypervisor 103 is able to replicate the data read by the load operator from the physical ACPI table 207 to the logical ACPI table 204 so that the load operator can be executed properly. In order to execute the replication process, in the embodiment, a function for editing the description of the contents of a control method process and a function for replicating data are added to the hypervisor 103.

Specifically, the hypervisor 103 adds a process description for replicating data from the physical ACPI table 207 to the logical ACPI table 204 in a step prior (for example, one step prior) to the load operator read area being declared. The address and size of the data to be read by the load operator at this point may change partway through the execution of the control method, and as such, in the embodiment, the description is arranged one step prior to the load operator area being declared so that the replication process is executed. For example, in the case of the control method that includes the load operator shown in FIG. 3, the address and size of the data to be read by the load operator is not determined until the processing corresponding to line 14. Accordingly, the hypervisor 103 adds a process description for replicating the data to be read by the load operator in line 16, one step prior to declaring the area of the data to be read by the load operator.

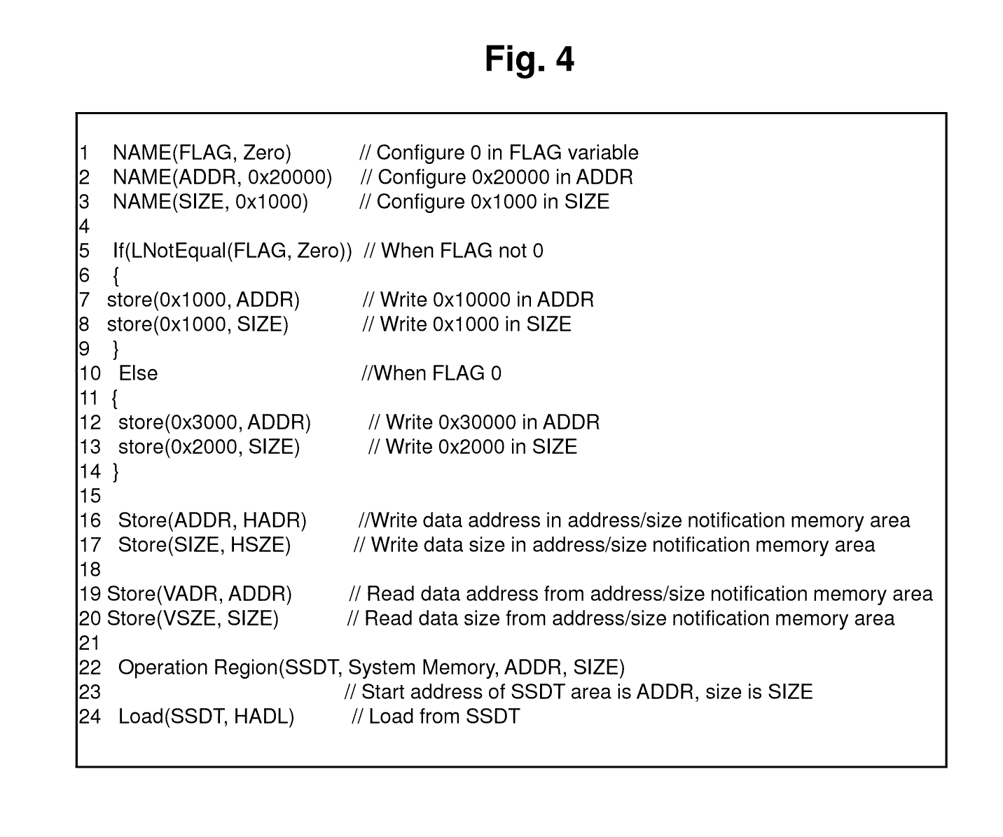

FIG. 4 is a drawing showing an example of a control method including a load operator related to the embodiment. FIG. 4 shows an example of a control method after editing has been performed to add a process description for replicating data to the control method shown in FIG. 3. This control method is stored in the logical memory 107 of the virtual machine 105.

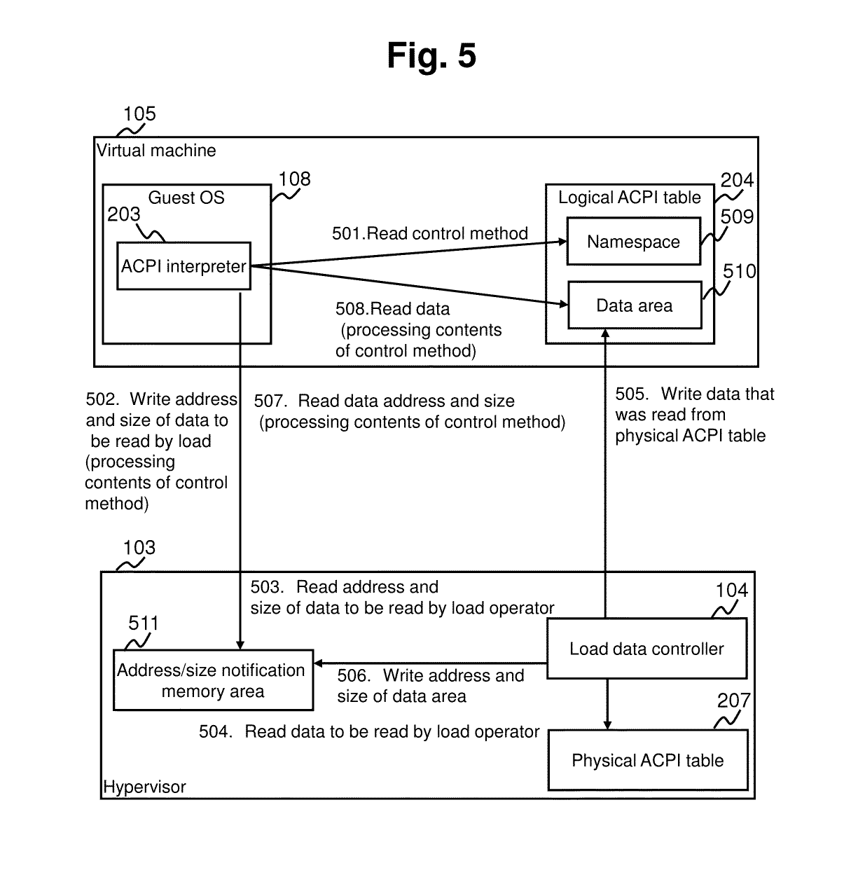

The descriptions from line 1 through line 14 of the control method are the same as the descriptions from line 1 through line 14 of the control method of FIG. 3. Line 16 and line 17 of the control method are descriptions for processes for writing the values of the address and the size of the memory area for the data to be read by the load operator into a memory area for the virtual machine 105 and the hypervisor 103 to notify one another of the address and the size (referred to hereinbelow as the address/size notification memory area 511 (refer to FIG. 5)). The address/size notification memory area 511 is a memory area of the physical memory 102 other than the memory area that has been provided to the logical memory 107. The address/size notification memory area 511 is capable of being accessed by the logical CPU 106 of the virtual machine 105. The hypervisor 103, based on address and size writes to the address/size notification memory area 511, reads the data of the area corresponding to the physical ACPI table 207. Next, the hypervisor 103 writes the read data to the logical ACPI table 204, and writes the address and the size of the data written into the logical ACPI table 204 to the address/size notification memory area 511. The address written at this point is the address in the logical memory 107 of the corresponding virtual machine 105.

The descriptions of line 19 and line 20 of the control method are for performing processes for the control method to acquire the address and the size of the data written to the logical ACPI table 204 from the address/size notification memory area 511. The address and the size of the data to be read by the load operator are determined by executing the processing corresponding to the descriptions of lines 19 and 20. The description in line 22 of the control method is for declaring the memory area to be read by the load operator. The description in line 24 of the control method is for executing the load operator.

FIG. 5 is a drawing showing a summary of processing at load operator execution related to the embodiment.

The virtual machine 105 comprises a guest OS 108 and a logical ACPI table 204. The guest OS 108 comprises an ACPI interpreter 203. The logical ACPI table 204 comprises a namespace 509 and a data area 510. The namespace 509 is for holding a description of the processing content of the control method, a variable value, and so forth. The data area 510 is for writing the data to be read by the load operator.

The hypervisor 103 comprises an address/size notification memory area 511, a load data controller 104, and a physical ACPI table 207. The address/size notification memory area 511 is a memory area for exchanging the address and the size of data to be read by the load operator between the control method (virtual machine 105) and the hypervisor 103. The address/size notification memory area 511 is reserved beforehand in an area of the physical memory 102 other than the area allocated to the logical memory 107. The address/size notification memory area 511 is capable of being accessed by the logical CPU 106 of the virtual machine 105. The load data controller 104 is a functional unit for controlling the data to be read by the load operator, and performs, among other things, the process for replicating the data from the physical ACPI table 207 to the data area 510.

An overview of the flow of processing when the control method shown in FIG. 4 is stored in the namespace 509 and the control method is executed will be explained here.

In the virtual machine 105, the ACPI interpreter 203 reads the control method from the namespace 509 (Step 501), and sequentially processes the read control method. Since an example of the execution of the load operator is illustrated in FIG. 5, explanations of the processing corresponding to the descriptions from line 1 through line 15 of the control method shown in FIG. 4, which are not directly related to the execution of the load operator, will be omitted here.

The ACPI interpreter 203 reads the address and the size of the data to be read by the load operator into the address/size notification memory area 511 by executing the processing corresponding to the descriptions in line 16 and line 17 of the control method (Step 502).

When the address and the size have been written to the address/size notification memory area 511 like this, the load data controller 104 of the hypervisor 103 reads the address and the size of the data to be read by the load operator from the address/size notification memory area 511. The address and the size here are the values written in Step 502.

Next, the load data controller 104 uses the acquired address and size, reads the data to be read by the load operator from the physical ACPI table 207 (Step 504), and writes the read data to the data area 510 of the virtual machine 105 (Step 505). The method for determining the start address and size of the data area 510 for writing the data at this point will be explained below.

The load data controller 104 writes the address and the size of the data that has been written to the data area 510 to the address/size notification memory area 511 (Step 506).

The ACPI interpreter 203 reads the address and the size that have been written to the address/size notification memory area 511 by executing the descriptions in line 19 and line 20 of the control method (Step 507).

Next, the ACPI interpreter 203 declares the memory area to be read by the load operator by performing the processing of line 22 of the control method, and by executing the description of line 24 of the control method, reads the data to be replicated in the data area 510 by executing the load operator on the basis of the address and the size acquired in Step 507 (Step 508).

In explaining a memory map of the physical memory 102 in the virtual machine system here, first a memory map of a physical memory in a non-virtual machine system in which a single OS is running on the physical resources will be explained.

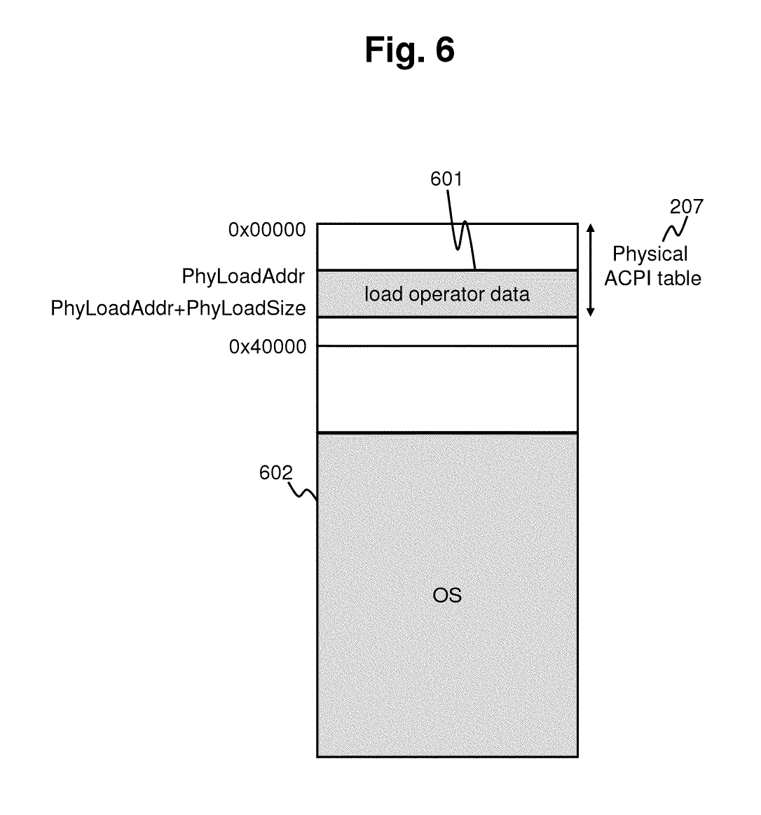

FIG. 6 shows an example of a memory map in a non-virtual machine system.

In a non-virtual machine system, as shown in FIG. 6, the data targeted to be read by the load operator is in the load operator data 601 inside the physical ACPI table 207. The load operator data 601 is stored in an area from the “PhyLoadAddr” to the “PhyLoadAddr+PhyLoadSize”, but the “PhyLoadAddr” and “PhyLoadAddr+PhyLoadSize” are not uniquely determined until the load operator is executed. The “PhyLoadAddr” is the start address of the load operator data 601 in the physical ACPI table 207, and the “PhyLoadSize” is the size of the load operator data 601 in the physical ACPI table 207. When the OS 602 of the non-virtual machine system executes the load operator, the “PhyLoadAddr” and the “PhyLoadAddr+PhyLoadSize” are uniquely determined, and as such, the data is read directly from the load operator data 601 using the values.

A memory map in a virtual machine system in which a virtual machine is running will be explained next.

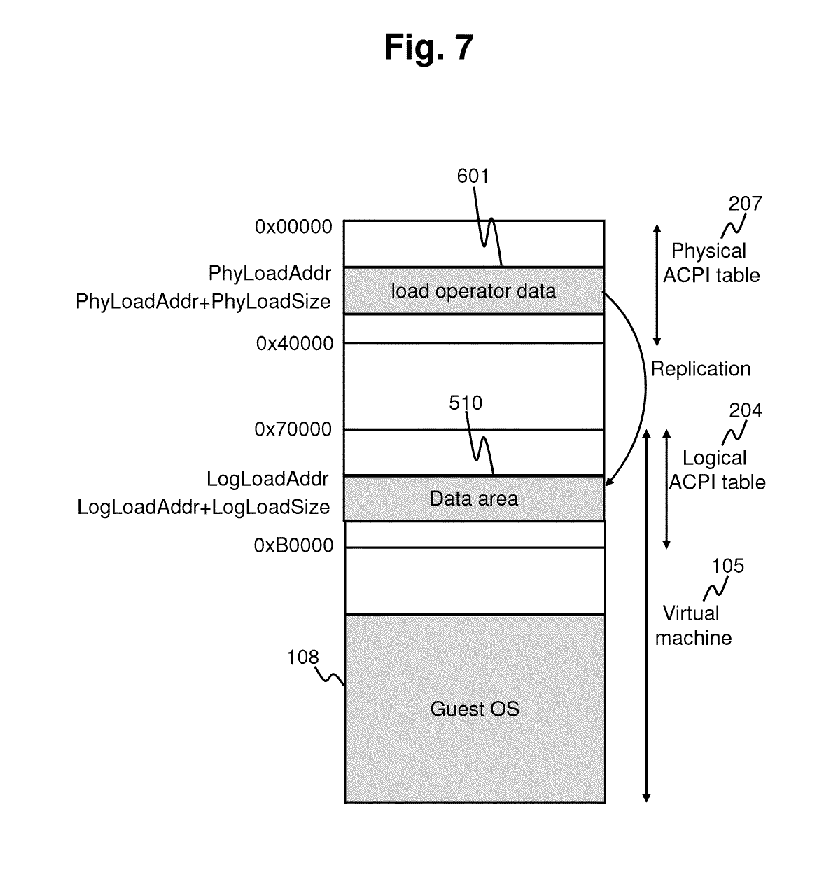

FIG. 7 is a drawing showing an example of a memory map in a virtual machine system related to the embodiment.

In the virtual machine system, the data targeted to be read by the load operator is in the load operator data 601 inside the physical ACPI table 207. The load operator data 601 is stored in an area from the “PhyLoadAddr” to the “PhyLoadAddr+PhyLoadSize”, but the “PhyLoadAddr” and “PhyLoadAddr+PhyLoadSize” are not uniquely determined until the load operator is executed.

The virtual machine 105 has a data area 510 and a guest OS 108 area in the logical ACPI table 204. The logical ACPI table 204 is created based on the physical ACPI table 207, and therefore the address and the size of the data described in the load operator are the “PhyLoadAddr” and the “PhyLoadSize”, respectively. When the guest OS 108 executes the load operator at this point, the “PhyLoadAddr” described in the load operator is the address (referred to as virtual address hereinbelow) on the virtual machine 105 (that is, the logical memory 107), and as such, differs from the physical memory 102 address that is actually accessed. It is assumed that the virtual address will be specified hereinbelow only when making a statement regarding the virtual address, and when not specified, that the pertinent address will be an address in the physical memory 102. The virtual address “PhyLoadAddr” indicates an area from the start address of the logical memory 107 allocated to the virtual machine 105 to the “PhyLoadAddr” destination address, and as the physical memory 102 address, becomes “0x70000+PhyLoadAddr”. The start address of the logical memory 107 will be explained here as “0x70000”.

Thus, the start address “LogLoadAddr” of the data area 510 is the “0x70000+PhyLoadAddr”, and the size “LogLoadSize” is the “PhyLoadSize”. The “LogLoadAddr” and the “LogLoadSize” are not determined until the “PhyLoadAddr” and the “PhyLoadSize” of the load operator data 601 have been determined, and the corresponding memory area cannot be replicated in a fixed manner beforehand.

When a memory area from the “0x70000+PhyLoadAddr” to the “0x70000+PhyLoadAddr+PhyLoadSize” is already being used, it is not possible to replicate data in this memory area, and in this case, the data is replicated in a free area, and the virtual machine 105 must change the virtual address and the size to be read by the load operator in accordance with the memory area storing the data.

Next, the processing operations in the virtual machine system related to the embodiment will be explained in detail.

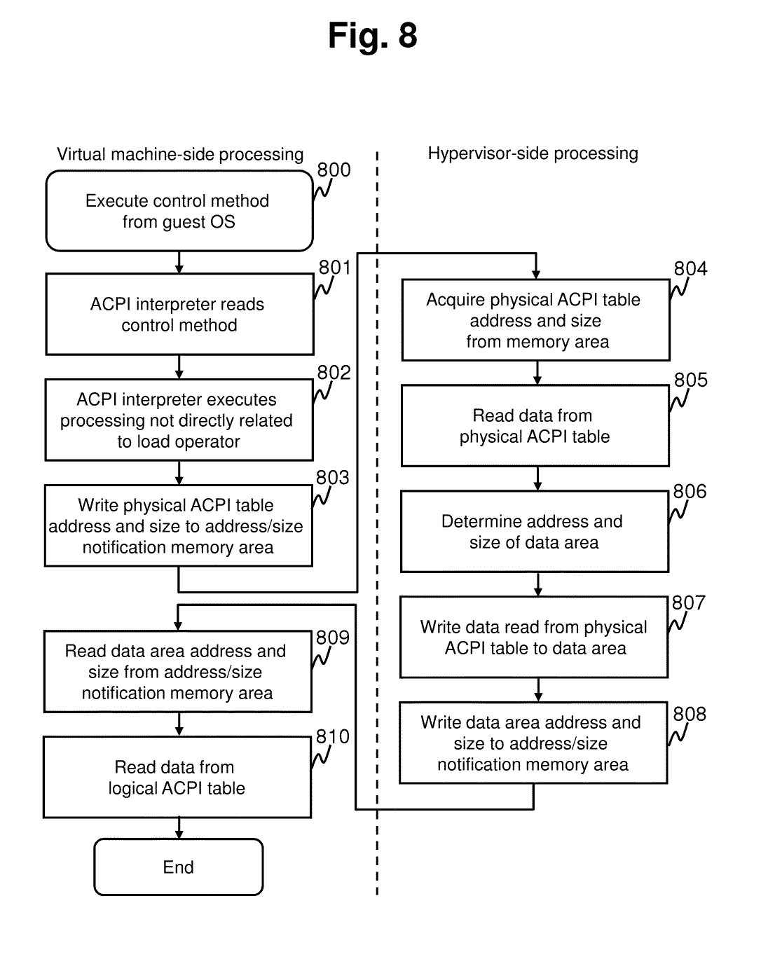

FIG. 8 is a flowchart of the control method execution process related to the embodiment.

The control method including the load operator shown in FIG. 4 will be explained here as being stored in the logical ACPI table 204. The method for creating the control method shown in FIG. 4 will be explained below.

When the virtual machine 105 guest OS 108 fetches the control method execution instruction (Step 800 (corresponds to Step 501 of FIG. 5)), the ACPI interpreter 203, based on the execution instruction, sequentially reads the contents of the control method processing from the namespace 509 in the logical ACPI table 204 (Step 801). In the case of a control method that includes the load operator, processing corresponding to the descriptions up to the replication process added by the control method edit process, which will be explained below (processing corresponding to the descriptions up to line 15 shown in FIG. 4), is not related to the addition process for executing the load operator, and as such, is sequentially executed by the ACPI interpreter 203 (Step 802). These processes are the processes in the control method (control method shown in FIG. 3) of prior to the control method edit.

Next, the ACPI interpreter 203 writes the address and the size of the data to be read by the load operator to the address/size notification memory area 511 on the basis of the descriptions in lines 18 and 19 of the control method (Step 803 (corresponds to Step 502 of FIG. 5)).

Thereafter, the processing of Step 804 through Step 808 is executed by the load data controller 104 of the hypervisor 103.

That is, the hypervisor 103 load data controller 104 acquires the address and the size to be written in Step 803 from the address/size notification memory area 511 (Step 804 (corresponds to Step 503 of FIG. 5)).

Next, on the basis of the acquired address and size, the load data controller 104 reads data from the memory area corresponding to the physical ACPI table 207 (Step 805 (Step 504 of FIG. 5)).

Next, the load data controller 104 determines the start address and the size of the data area 510 for writing the read data (Step 806). When a memory area the size of the data is unused from an address corresponding to the sum of the virtual address of the data to be read by the load operator and the start address of the memory area in the logical memory 107 allocated to the virtual machine 105, the load data controller 104 determines the memory area as the data area 510. Alternatively, when the memory area is already being used, the load data controller 104, from among the unused areas of the logical memory 107 of the virtual machine 105, determines as the data area 510 a memory area that has the lowest start address, and, in addition, can ensure the required size.

Next, the load data controller 104 writes the data read from the physical ACPI table 207 to the data area 510 (Step 807), and writes the address (virtual address) and the size of the data area 510 to the address/size notification memory area 511 (Step 808).

Next, the ACPI interpreter 203 of the virtual machine 105 acquires the address and the size of the data area 510 from the address/size notification memory area 511 on the basis of the descriptions in lines 18 and 19 of the control method (Step 809), and, on the basis of the acquired address and size, reads the target data from the logical ACPI table 204 by executing the load operator (Step 810).

The control method executed by the guest OS 108 is defined in the logical ACPI table 204, and the logical ACPI table 204 is created on the basis of the physical ACPI table 207. In order to execute the control method including the load operator defined in the logical ACPI table 204, the data to be read must be replicated from the physical ACPI table 207 to the logical ACPI table 204 before executing the load operator. When the address and the size of the data to be read by the load operator are defined by variables at this time, it is not possible to perform a replication process that replicates the corresponding data in a fixed manner. In contrast thereto, in the embodiment, the ACPI interpreter 203 in Step 803 notifies the hypervisor 103 of the address to be read by the load operator, in Step 804 through Step 808, the hypervisor 103 performs a replication process for replicating the data to be read by the load operator from the physical ACPI table 207 to the logical ACPI table 204, in Step 809, the virtual machine 105 acquires the address of the replicated data, and in Step 810, the virtual machine 105 executes the load operator. Thus, the process for replicating the data from the physical ACPI table 207 to the logical ACPI table 204 is performed one step prior to Step 810 via which the load operator is executed. At this time point, the address and the size of the data to be read by the load operator are uniquely determined even when defined using variables, and the data replication process can be executed properly.

In the embodiment, Step 803 and Step 809 here are executed in accordance with descriptions added by an edit process with respect to the control method. The OS (guest OS 108) is not created on the assumption that the ACPI table (logical ACPI table 204) will be rewritten after boot-up, and as such, the control method edit process is implemented by the hypervisor 103 prior to the guest OS 108 being booted up, that is, when the virtual machine 105 is created.

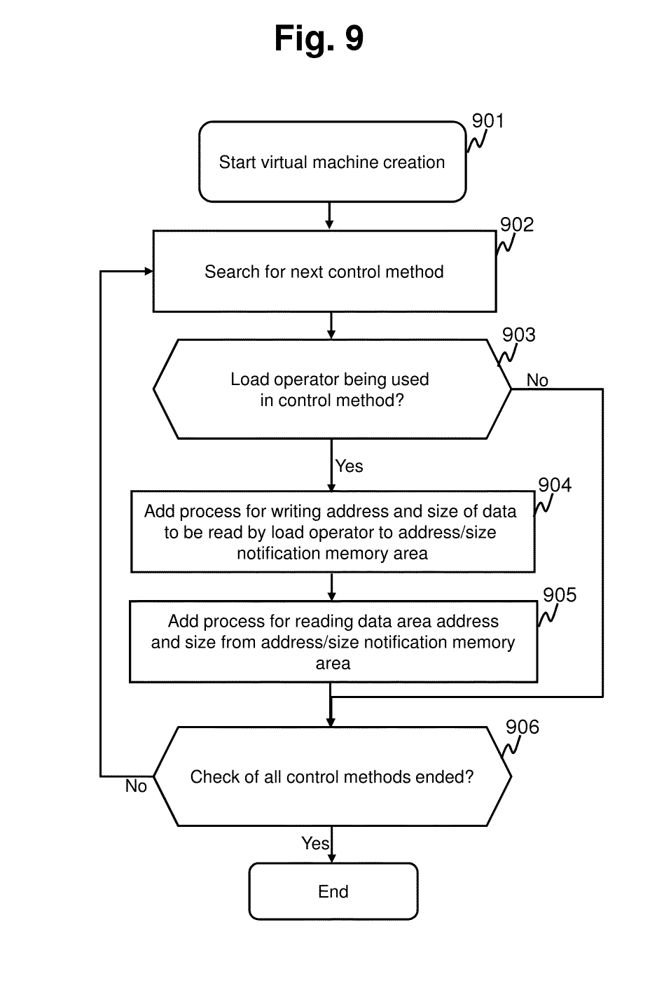

FIG. 9 is a flowchart of the control method edit process related to the embodiment.

The hypervisor 103 starts creating a virtual machine 105 (Step 901). The creation of the virtual machine 105 is performed prior to booting up the guest OS 108, and logical resources, such as the logical ACPI table 204, are created.

The hypervisor 103 searches for and acquires the next processing-target control method from the logical ACPI table 204 (Step 902), and checks whether or not the load operator in the control method is being used (Step 903). When the result is that the load operator is not being used in the control method (Step 903: No), the hypervisor 103 advances the processing to Step 906.

Alternatively, when the load operator is being used in the control method (Step 903: Yes), the hypervisor 103 performs processing for adding descriptions to the control method (Steps 904 and 905). In Step 904, the hypervisor 103 adds to the control method descriptions (lines 16 and 17 in the control method of FIG. 4) for processing that writes the address and the size of the data to be read by the load operator into the address/size notification memory area 511. In Step 905, the hypervisor 103 adds to the control method descriptions (lines 19 and 20 in the control method of FIG. 4) for processing for acquiring the address and the size of the data area 510 from the address/size notification memory area 511.

Next, in Step 906, the hypervisor 103 determines whether or not the check has ended for all the control methods, and when the check has ended for all the control methods (Step 906: Yes), ends the control method edit process. Alternatively, when the check has not ended for all the control methods (Step 906: No), the hypervisor 103 moves the processing to Step 902 and performs the processing for the next processing-target control method.

One embodiment has been explained hereinabove, but it goes without saying that the present invention is not limited to this embodiment, and that various changes are possible within a scope that does not depart from the gist thereof.

For example, in the above-described embodiment, an example of a case in which a load operator is executed was explained, but the present invention is not limited thereto, and the present invention can be applied in the case of an AML function that reads data specified in a physical memory address.

### REFERENCE SIGNS LIST

100 Physical computer resources
101 Physical CPU
102 Physical memory
103 Hypervisor
104 Load data controller
105 Virtual machine
106 Logical CPU
107 Logical memory
108 Guest OS
203 ACPI interpreter
204 Logical ACPI table
207 Physical ACPI table
509 Namespace
510 Data area
511 Address/size notification memory area

1. A virtual machine system capable of running a plurality of virtual machines, comprising:
a memory; and
a processor coupled to the memory,
wherein the memory is configured to store a physical APCI (Advanced Configuration and Power Interface) table,
wherein the processor is configured to operate as a virtual machine management part for managing the virtual machines and logical processors for the virtual machines,
wherein the virtual machine management part is configured to create, on the basis of the physical APCI table, logical APCI tables in logical memory areas, which are memory areas in the memory and are allocated to the virtual machines,
wherein a logical processor is configured to
store, in an exchange memory area, an address and a size of a memory area of the memory that is targeted for access by a prescribed function in a control method included in the logical APCI table,
wherein the virtual machine management part is configured to
acquire the address and the size from the exchange memory area, and acquire data of the memory area corresponding to the address and the size from the memory, and
store the acquired data in the logical memory area allocated to the virtual machine, and
wherein the logical processor is configured to
acquire the logical memory area data of the memory.

2. The virtual machine system according to claim 1,
wherein the virtual machine management part is configured to
identify, from a control method in the physical ACPI table, a function for accessing a memory area of the memory, and
allow the logical processor to store an address and a size of the function access-target memory area in the exchange memory area, add to the control method a first description for allowing the acquisition of the address and the size from the exchange memory area, and, on the basis of the acquired address and the size, a second description for allowing the acquisition of data in the memory area corresponding to the logical memory area, and store the control method, to which the first and second descriptions have been added, in the logical ACPI table, and
wherein the logical processor is configured to execute the control method.

3. The virtual machine system according to claim 2,
wherein the virtual machine management part is configured to
add the first description and the second description immediately prior to a description for declaring a memory area to be accessed by the memory area-accessing function.

4. The virtual machine system according to claim 1,
wherein the virtual machine management part is configured to
store, in the exchange memory area, an address and a size in the logical memory area that stores the acquired data, and
wherein the logical processor is configured to
acquire the address and the size from the exchange memory area, and acquires the data from the logical memory area on the basis of the address and the size.

5. The virtual machine system according to claim 1,
wherein the virtual machine management part is configured to
determine whether or not a memory area corresponding to the address and the size in the logical memory area is unused,
store the acquired data in the area and store the address and size of the memory area in the exchange area, when the memory area is unused,
detect a free area from the logical memory area, store the data in the free area, and store the free area address and size in the exchange memory area, when the memory area is in use, and
wherein the logical processor is configured to
acquire the address and the size from the exchange memory area, and acquire the data from the logical memory area on the basis of the address and the size.

6. A virtualization mechanism for allowing the execution on a computer that can operate a plurality of virtual machines, the virtualization mechanism allowing the computer to execute processing for:
creating, on the basis of a physical APCI table stored in a memory, a logical APCI table in a logical memory area, which is a memory area in the memory and is allocated to the virtual machine,
acquiring, from an exchange memory area storing an address and a size of a memory area of the memory that is targeted for access by a prescribed function in a control method included in the logical APCI table, the address and the size, and acquiring from the memory data of the memory area corresponding to the address and the size; and
storing the acquired data in the logical memory area allocated to the virtual machine.

7. The virtualization mechanism according to claim 6 that allows the computer to execute processing for:
identifying, from a control method in the physical ACPI table, a function for accessing a memory area of the memory; and
allowing the virtual machine logical processor to store an address and a size of the function access-target memory area in the exchange memory area, adding to the control method a first description for allowing the acquisition of the address and the size from the exchange memory area, and, on the basis of the acquired address and the size, a second description for allowing the acquisition of data in the memory area corresponding to the logical memory area, and storing the control method to which the first and second descriptions have been added in the logical ACPI table.

8. The virtualization mechanism according to claim 7 that allows the computer to execute processing for:
adding the first description and the second description immediately prior to a description for declaring a memory area to be accessed by the function for accessing the memory area.

9. The virtualization mechanism according to claim 6 that allows the computer to execute processing for:
storing in the exchange memory area an address and a size in the logical memory area that stores the acquired data.

10. The virtualization mechanism according to claim 6 that allows the computer to execute processing for:
determining whether or not a memory area corresponding to the address and the size in the logical memory area is unused, and when the memory area is unused, storing the acquired data in the area and storing the memory area address and size in the exchange area, and when the memory area is in use, detecting a free area from the logical memory area, storing the data in the free area, and storing the free area address and size in the exchange memory area.

11. A data management method comprising:
creating, by a virtual machine management part, on the basis of a physical APCI table stored in a memory, a logical APCI table in a logical memory area, which is a memory area in the memory and is allocated to the virtual machine;
storing, by a logical processor of a virtual machine, in a prescribed exchange memory area, an address and a size of a memory area of the memory that is targeted for access by a prescribed function in a control method included in the logical APCI table;
acquiring, by the virtual machine management part, the address and the size from the exchange memory area, and acquiring data of the memory area corresponding to the address and the size from the memory;
storing, by the virtual machine management part, the acquired data in the logical memory area allocated to the virtual machine; and
acquiring, by the logical processor, the logical memory area data of the memory.

12. The data management method according to claim 11, comprising:
identifying, by the virtual machine management part, from the control method in the physical ACPI table, a function for accessing a memory area of the memory;
allowing, by the virtual machine management part, the logical processor to store an address and a size of the function access-target memory area in the exchange memory area, adding, by the virtual machine management part, to the control method a first description for allowing the acquisition of the address and the size from the exchange memory area, and, on the basis of the acquired address and the size, a second description for allowing the acquisition of data in the memory area corresponding to the logical memory area, and storing, by the virtual machine management part, the control method, to which the first and second descriptions have been added, in the logical ACPI table; and
executing, by the logical processor, the control method.

13. The data management method according to claim 12, comprising:
adding, by the virtual machine management part, the first description and the second description immediately prior to a description for declaring a memory area to be accessed by the function for accessing the memory area.

14. The data management method according to claim 11, comprising:
storing, by the virtual machine management part, in the exchange memory area, an address and a size in the logical memory area where the acquired data is stored; and
acquiring, by the logical processor, the address and the size from the exchange memory area, and acquiring the data from the logical memory area on the basis of the address and the size.

15. A data management method according to claim 11, comprising:
determining, by the virtual machine management part, whether or not a memory area corresponding to the address and the size in the logical memory area is unused,
storing, by the virtual machine management part, the acquired data in the area and storing the memory area address and size in the exchange area, when the memory area is unused;
detecting, by the virtual machine management part, a free area from the logical memory area, and storing the data in the free area, and storing the free area address and size in the exchange memory area, when the memory area is in use; and
acquiring, by the logical processor, the address and the size from the exchange memory area, and acquiring the data from the logical memory area on the basis of the address and the size.
